(19) United States
(12) Patent Application Publication
(10) Pub. No.: US 2005/0133591 A1
(43) Pub. Date: Jun. 23, 2005

(54) Control method and control device during fabrication of cards

(75) Inventor: Jan Persson, Ljungby (SE)

Correspondence Address: TAROLLI, SUNDHEIM, COVELL & TUMMINO L.L.P., SUITE 1111, 526 SUPERIOR AVENUE, CLEVELAND, OH, 44114-1400, US

(73) Assignee: Stralfors AB

(21) Appl. No.: 11/010,750

(22) Filed: Dec. 13, 2004

(30) Foreign Application Priority Data
Dec. 17, 2003 (SE) 0303386-7

(51) Int. Cl. G06K 5/00

(52) U.S. Cl. 235/380

(57) ABSTRACT

The present invention relates to a control method and a control device during fabrication of a series of cards (2), preferably credit or ledger cards, in which series each card (2) has hobbed symbols (3) which represent individual information (4-6) about the card possessor or card holder, e.g. his or her name and card number. The hobbed symbols (3) on each card (2) in the series are read by a laser emitter/receiver (8) emitting laser light (10) towards the cards (2) and receiving laser light (12) from said cards. Information obtained during reading and representing the hobbed symbols (3) of the cards (2), is compared with predetermined information for controlling if said informations correspond. An error is indicated if said informations do not correspond.

The present invention relates to a control method and a control device during fabrication of a series of cards, preferably credit or ledger cards, in which series each card has hobbed symbols, preferably the name of the card possessor or card holder and the card number.

GB 2205529 A illustrates in FIG. 17 and describes in the associated text a control method during which erroneous positions are detected by reading cards by means of a laser.

In other prior art control methods, the text on cards is read by means of cameras. If the cards are provided with images or shiny coatings, e.g. metal coatings, the camera reading is disturbed, which can lead to faults, particularly if quick reading of the cards is required when they move quickly relative to the camera.

The object of the present invention has been to remedy this problem and this is done according to the invention by providing the initially defined control method and the initially defined control device with the characterizing measures and features respectively, of subsequent claims 1 and 17.

By carrying through the control measures and reading the individual information about the card possessor on the card by means of laser light, a safe reading of the cards for various purposes is ensured even if the cards are moved at high speed and even if the cards are provided with all sorts of information and/or images not hobbed into the cards.

The invention will be further described below with reference to the accompanying drawings, in which

FIG. 1 is a schematic side view of a control device according to the invention during control of cards;

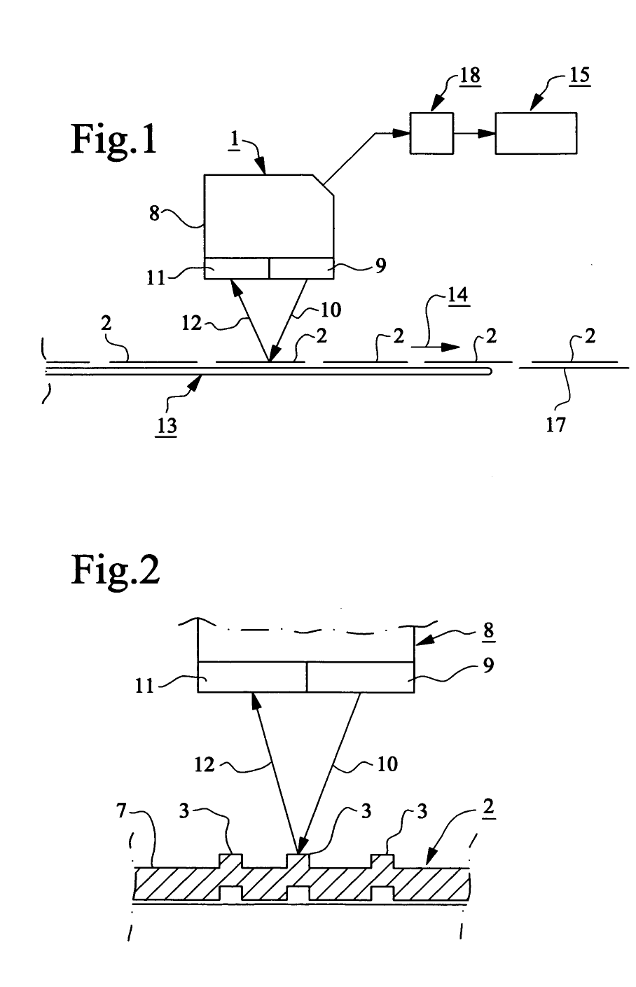

FIG. 2 is a side view of an enlarged part of the device of FIG. 1 with portions of a card in section;

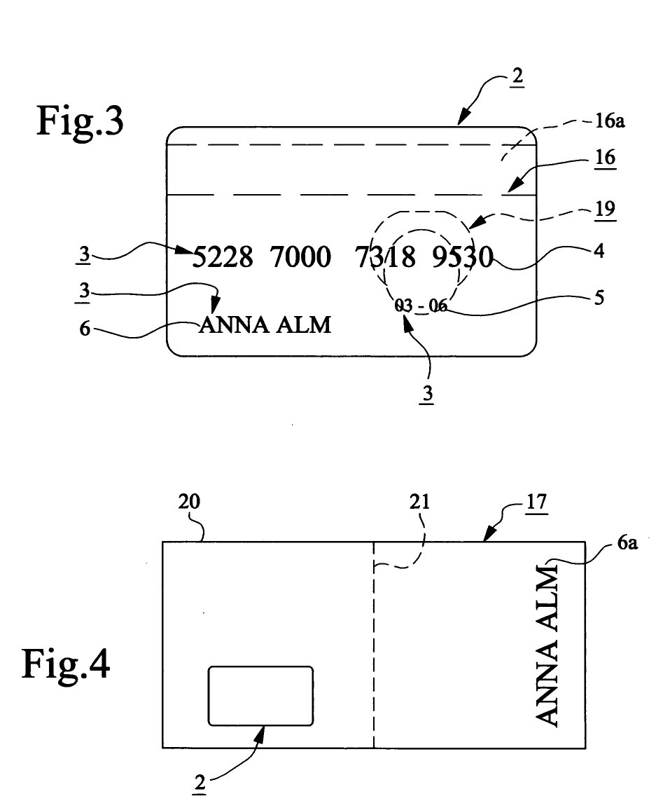

FIG. 3 is a plan view of a card during control thereof; and

FIG. 4 is a plan view of a card during control thereof and a carrier on which the card is situated.

The control device 1 illustrated in the drawings is adapted for control of individual cards 2 forming part of a series and each card has different hobbed symbols 3.

The cards 2 are preferably credit or ledger cards and the hobbed symbols 3 preferably represent information which is individual for the card possessor or card holder, e.g. digits in a card number, an account number 4, numbers representing year and month 5 and the name 6 of the card possessor.

With hobbed symbols is meant symbols which are hobbed to protrude from the upper side 7 of the card 2 as is illustrated in FIG. 2.

The control device 1 comprises a laser emitter/receiver 8 which has an emitter 9 for emitting laser light 10 towards the cards 2 and a receiver 11 for receiving laser light 12 reflected by the cards 2. The laser emitter/receiver 8 is in this embodiment fixedly mounted above a schematically illustrated transport or conveying path 13, along which the cards 2 in the series of cards are located after each other when they are transported or fed at high speed in the direction of the arrow 14.

The laser light 10 of the laser emitter/receiver 8 is adapted to read the hobbed symbols 3 of the cards 2, whereby the reflected laser light 12 provides information about the read hobbed symbols 3 on each individual card. This information is transmitted electronically to a comparing device 15 with software or similar for comparing the information obtained during reading, representing the hobbed symbols 3 of the individual cards, with predetermined information for controlling if said informations correspond.

The comparing device 15 can be programmed with various predetermined information with which the read information shall correspond. Examples of such information are individual information about the account holder, e.g. his or her name, birth date, card number or any other individual information. This information can be used for controlling that there is only one individual card in the fabricated series and/or for controlling that the account number 4 and/or the name 6 of the account holder are correctly stated on the card 2 and/or correspond. If there is no correspondence between the informations, this is indicated as an error such that the error can be corrected.

Information which can be controlled is if an individual card 2 passes the laser emitter/receiver 8 only once for each series, since of course two or more cards 2 with the same information may not pass. Other information which can be controlled is if all information on the card 2 is correct and correspond. Thus, it is also possible to control if the hobbed symbols 3 correspond with information 16a on a magnetic tape 16 if there is such a tape on the card 2. The card 2 can be attached to a carrier 17, e.g. a sheet 20 which can be used as a postal packet or formed into such a packet. Thus, the sheet 20 can be folded along a line 21 into a double folded card or letter which can be sealed. Additional information which can be controlled is whether the information on a card 2 corresponds with information on a carrier 17. The sheet 20 can be provided with the name of the card possessor and the name 6 on the card 2 can be compared in the comparing device 15 with the name 6a on the packet 17 in order to ensure that the packet is sent to the right person.

The comparing device 15 may also be used for comparing information about the number of cards 2 passing said device with information about the number of cards included in the series. Hereby, it is possible to control if the number of produced cards 2 is correct or if any is missing or if there erroneously is any duplicate.

A discerning device 18 can be provided to discern control information from uninteresting information and this can be carried through by means of software or similar found in the discerning device 18. The discerning device 18 may e.g. separate information obtained from hobbed symbols 3 found above the upper side 7 of the cards 2. Hereby, it is ensured that a correct reading is taken even if the upper side 7 is not level, i.e. the card 2 is bent.

The laser emitter/receiver 8 can be of any suitable type, but it should be mentioned that a semiconductor laser (diode laser) operates with good results for the control in question. Such a semiconductor laser can operate within a wave length range of 650-658 nm, it can emit and receive visible light and preferably emit light fields of such width that all hobbed symbols 3 on each card 2 can be read when they pass the light field.

The invention is not limited to what is described above and shown in the drawings, but may vary within the scope of the subsequent claims. Thus, it should be mentioned that the cards 2 may be of plastic and/or another suitable material and that the cards 2 can be adapted for various purposes, i.e. be credit or ledger cards, identity cards, membership cards etc. The cards 2 can be provided with information and/or images 19 of e.g. the card possessor, which are not hobbed, and this information and/or images may be in colour or in black and white.

1. Control method during fabrication of a series of cards (2), preferably credit or ledger cards, in which series each card (2) has hobbed symbols (3) which represent individual information (4-6) about the card possessor or card holder, e.g. his or her name and card number,
characterized in
that the hobbed symbols (3) on each card (2) in the series are read by a laser emitter/receiver (8) emitting laser light (10) towards the cards (2) and receiving laser light (12) from said cards,
that information obtained during reading, representing the hobbed symbols (3) of the cards (2), is compared with predetermined information for controlling if said informations correspond, and
that an error is indicated if said informations do not correspond.

2. Control method according to claim 1, characterized in that information obtained during reading, representing personal information (5, 6) about the card possessor or card holder and/or the personal card number (4) of the card possessor or card holder, is compared with personal information and/or information about the card number in a comparing device (15).

3. Control method according to claim 1, characterized in that information about which individual cards (2) pass the laser emitter/receiver (8) is compared with information about that there shall be only one individual card (2) in the series, for controlling that no more of an individual card (2) has been fabricated for the series and/or for controlling if various information on the card (2) is correctly stated and/or corresponds with predetermined information.

4. Control method according to claim 1, characterized in that information according to the hobbed symbols (3) on each card is compared with magnetic tape information (16a) on the card (2), for controlling if information according to the hobbed symbols (3) and the magnetic tape information (16a) correspond.

5. Control method according to claim 1, characterized in that the number of cards (2) passing the laser emitter/receiver (8) is read and information about that is compared with information about the given number of cards (2) included in the series, for controlling if the number of fabricated cards (2) is correct.

6. Control method according to claim 1, characterized in that the control information read, is separated from uninteresting information.

7. Control method according to claim 6, characterized in that information from such parts of the hobbed symbols (3) which are found above an upper side (7) of the card (2) is separated from other information for comparison with predetermined information.

8. Control method according to claim 1, characterized in that the cards (2) in the series are during reading moved relative to the laser emitter/receiver (8).

9. Control method according to claim 1, characterized in that the laser light (10) for reading the hobbed symbols (3) of the cards (2) is generated by a laser emitter/receiver (8) in the form of a semiconductor laser.

10. Control method according to claim 1, characterized in that the laser emitter/receiver (8) emitting and receiving the laser light (10) for reading the hobbed symbols (3) of the cards (2), operates within a wave length range of 650-658 nm.

11. Control method according to claim 1, characterized in that the laser light (10) emitted by the laser emitter/receiver (8) for reading the hobbed symbols (3) of the cards (2) is visible.

12. Control method according to claim 1, characterized in that the laser emitter/receiver (8) emitting and receiving the laser light (10) for reading the hobbed symbols (3) of the cards (2), has a width permitting reading of all hobbed symbols (3) of each card (2) when said card passes the laser emitter/receiver (8).

13. Control method according to claim 1, characterized in that the card (2) is a credit or ledger card with information that is not hobbed and/or images (19) that are not hobbed of e.g. the face of the card possessor or card holder.

14. Control method according to claim 1, characterized in that information about hobbed symbols (3) of each individual card (2) is compared with information about a carrier (17) to which the individual card (2) shall be attached, for controlling that each individual card (2) is attached to the right carrier (17).

15. Control method according to claim 14, characterized in that information about a name (6) on the card (2) is compared with corresponding information about the name (6a) on the carrier (17).

16. Control method according to claim 14, characterized in that the carrier (17) is designed as a postal packet or can be formed into such a postal packet.

17. Control device during fabrication of a series of cards (2), preferably credit or ledger cards, in which series each card (2) has hobbed symbols (3) which represent individual information (4-6) about the card possessor or card holder, e.g. his or her name and card number,
characterized in
that a laser emitter/receiver (8) is provided to emit laser light (10) towards the cards (2) in the series and receive reflected laser light (12) from the cards for reading the hobbed symbols (3) of the cards, and
that a comparing device (15) is provided to compare, by means of software or similar, information obtained during reading and representing the hobbed symbols (3) of the cards (2) with predetermined information, for controlling if said informations correspond, whereby an error is indicated if said informations do not correspond.

18. Control device according to claim 17, characterized in that the comparing device (15) is provided to compare obtained information, representing personal information (5, 6) about the card possessor or card holder and/or his or her personal card number (4), with personal information and/or information about the credit or ledger card number.

19. Control device according to claim 17, characterized in that the comparing device (15) is provided to compare information about which individual cards (2) pass the laser emitter/receiver (8) with information about that only one such individual card (2) shall pass, for controlling that no more than one individual card (2) passes the laser emitter/receiver (8) and/or for controlling if various information on the card (2) is correctly stated and/or corresponds with predetermined information.

20. Control device according to claim 17, characterized in that the comparing device (15) is provided to compare information according to the hobbed symbols (3) on each card (2) with magnetic tape information (16a) on the card (2), for controlling that these informations correspond.

21. Control device according to claim 17, characterized in that the comparing device (15) is provided to compare information about the number of cards (2) passing the laser emitter/receiver (8) with information about the given number of cards (2) included in the series, for controlling if the number of fabricated cards (2) is correct.

22. Control device according to claim 17, characterized in that a discerning device (18) is provided to separate the control information read, from uninteresting information.

23. Control device according to claim 17, characterized in that a discerning device (18) is provided to separate information from such parts of the hobbed symbols (3) which are found above an upper side (7) of the card (2) from other information, for comparison with predetermined information.

24. Control device according to claim 17, characterized in that the cards (2) in the series are located on a transport or conveying path (13) for movement relative to the laser emitter/receiver (8).

25. Control device according to claim 17, characterized in that the laser emitter/receiver (8) is a semiconductor laser.

26. Control device according to claim 17, characterized in that the laser emitter/receiver (8) operates within a wave length range of 650-658 nm.

27. Control device according to claim 17, characterized in that the laser emitter/receiver (8) emits visible light.

28. Control device according to claim 17, characterized in that the laser emitter/receiver (8) emits laser light (10) of such a width that all hobbed symbols (3) on the card (2) can be read when said card (2) passes said laser emitter/receiver (8).

29. Control device according to claim 17, characterized in that the card (2) is a credit or ledger card with information that is not hobbed and/or images (19) that are not hobbed, e.g., of the face of the card possessor or card holder.

30. Control device according to claim 17, characterized in that the comparing device (15) is provided to compare information about hobbed symbols (3) on each individual card (2) with information about a carrier (17) to which the individual card (2) shall be attached, for controlling that said individual card is attached to the carrier (17) intended therefor.

31. Control device according to claim 30, characterized in that the comparing device (15) is provided to compare information about a name (6) on the card (2) with corresponding information about the name (6a) on the carrier (17).

32. Control device according to claim 30, characterized in that the carrier (17) is designed as a postal packet or can be formed into such a postal packet.
